(19) United States
(12) Patent Application Publication
(10) Pub. No.: US 2026/0299871 A1
(43) Pub. Date: Oct. 1, 2026

(54) REMOTE EMULATED AUDIO INTERFACE

(71) Applicant: Hewlett-Packard Development Company, L.P., Spring, TX (US)

(72) Inventors: Matthew Bradow, Fort Collins, CO (US); Peter Andrew Seiler, Fort Collins, CO (US); J. Michael Stahl, Fort Collins, CO (US); Bryan Heckman, Fort Collins, CO (US); Joseph-Jonathan Salzano, Fort Collins, CO (US); Dylan James Lea, Fort Collins, CO (US)

(73) Assignee: Hewlett-Packard Development Company, L.P., Spring, TX (US)

(21) Appl. No.: 19/484,177

(22) PCT Filed: May 25, 2023
(86) PCT No.: PCT/US2023/023611

§ 371 Date: Nov. 13, 2025

(51) Int. Cl. G06F 3/16

(52) U.S. Cl. CPC G06F 3/162

(57) ABSTRACT

A non-transitory machine-readable storage medium comprising instructions executable by a processing resource of a computing device to cause the computing device to: receive an audio stream from a user computing device, wherein the audio stream corresponds to an audio signal from a physical audio interface coupled to the remote user's computer; generate an emulated audio device to provide the audio signal to a remote computing device using the audio stream, wherein the emulated audio device emulates the physical audio interface coupled to the user computing device; establish a communication link to the remote computing device, wherein the communication link corresponds to a physical connection communication protocol; and transmit the audio signal to the remote computing device using the emulated audio device and the communication link.

### BACKGROUND

Creative professionals who work with audio often require the ability to record and play back high-quality audio from workstations. In a traditional recording studio setting, artist and musicians have the ability to record sound through physical audio devices, which are physically linked to an audio engineer's workstation for further processing. This may not always be the case with remote collaborators and alternative audio streams. Current remote desktop solutions for recording and transmitting audio signals have limited audio capabilities. For example, audio streams from a host device are often compressed as part of a video codec, leading to low quality audio streams. It would be helpful for a remote audio system to provide an interface for professionals and other collaborators to record and edit audio streams while away from a studio or workstation without sacrificing quality of the sound.

### BRIEF DESCRIPTION OF THE DRAWINGS

Various features will now be described with reference to the following drawings. Throughout the drawings, reference numbers may be re-used to indicate correspondence between referenced elements. The drawings are provided to illustrate examples described herein and are not intended to limit the scope of the disclosure.

FIG. 1 illustrates an example remote emulated audio system for providing an audio signal to a remote computing device;

FIG. 2 illustrates an example of a collaborate remote emulated audio system;

FIG. 3 is a block diagram illustrating components of a remote device controller configure to execute processes for managing a remote emulated audio system;

FIG. 4 a flow diagram depicting an example routine for providing an audio signal through a remote emulated audio system to a remote computing device;

FIG. 5 is a flow diagram depicting an example routine for providing an audio signal through a remote emulated audio system to a user computing device;

FIG. 6 is a flow diagram depicting an example routine for providing a collaborate remote emulated audio interface.

### DETAILED DESCRIPTION

A remote audio system may be configured to utilize emulated audio devices to provide uncompressed or lossless audio signals between workstations. In a common application, the system may utilize an emulated audio device(s) to capture audio input and output over a connection, such as a USB, to transport audio content from a user computing device to a remote computing device, and vice versa.

Aspects of the present disclosure relate to a system of remote emulated audio devices for transmitting audio signals. In some aspects, the techniques described herein relate to a non-transitory machine-readable storage medium comprising instructions executable by a processing resource of a computing device to cause the computing device to: receive an audio stream from a user computing device, wherein the audio stream corresponds to an audio signal from a physical audio interface coupled to the remote user's computer; generate an emulated audio device to provide the audio signal to a remote computing device using the audio stream, wherein the emulated audio device emulates the physical audio interface coupled to the user computing device; establish a communication link to the remote computing device, wherein the communication link corresponds to a physical connection communication protocol; and transmit the audio signal to the remote computing device using the emulated audio device and the communication link.

In some aspects, the techniques described herein relate to a non-transitory machine-readable storage medium, the audio stream is uncompressed.

In some aspects, the techniques described herein relate to a non-transitory machine-readable storage medium, wherein the audio signal is uncompressed.

In some aspects, the techniques described herein relate to a non-transitory machine-readable storage medium, wherein the instructions further cause the remote computing device to receive the audio stream input signal by communicating with the user computing device over a network.

In some aspects, the techniques described herein relate to a non-transitory machine-readable storage medium, wherein the audio stream comprises a plurality of audio stream channel signals corresponding to audio signals from a plurality of physical audio interfaces coupled to the user's computer.

In some aspects, the techniques described herein relate to a non-transitory machine-readable storage medium, wherein the emulated audio device is one of a plurality of emulated audio devices corresponding to the plurality of audio stream channel signals.

In some aspects, the techniques described herein relate to a non-transitory machine-readable storage medium, wherein the audio stream includes a time code, and wherein the emulated audio device to provide the time code to the remote computing device.

In some aspects, the techniques described herein relate to a non-transitory machine-readable storage medium comprising instructions executable by a processing resource of a computing device to cause the computing device to: generate an emulated audio device to receive an audio signal from a remote computing device; establish a communication link between the emulated audio device and the remote computing device, wherein the communication link corresponds to a physical connection communication protocol; receive an audio signal from a physical audio interface coupled to the remote computing device; generate an audio stream corresponding to the audio signal received from the physical audio interface coupled to the remote computing device; and transmit the audio stream to a user computing device.

In some aspects, the techniques described herein relate to a non-transitory machine-readable storage medium, wherein the audio stream is uncompressed.

In some aspects, the techniques described herein relate to a non-transitory machine-readable storage medium, wherein the audio signal is uncompressed.

In some aspects, the techniques described herein relate to a non-transitory machine-readable storage medium, wherein the instructions further cause the computing device to transmit the audio stream by communicating with the user's computer over a network.

In some aspects, the techniques described herein relate to a non-transitory machine-readable storage medium, wherein the audio stream comprises a plurality of audio stream channel signals corresponding to audio signals from a plurality of physical audio interfaces coupled to the remote computing device.

In some aspects, the techniques described herein relate to a non-transitory machine-readable storage medium, wherein the emulated audio device is one of a plurality of emulated audio devices corresponding to the plurality of audio stream channel signals.

In some aspects, the techniques described herein relate to a non-transitory machine-readable storage medium comprising instructions executable by a processing resource of a computing device to cause the computing device to: receive first audio stream information from a first remote user computing device, wherein the first audio stream corresponds to a first audio signal from a physical audio interface coupled to the first remote user's computer; receive second audio stream information from a second remote user's computer, wherein the second audio stream corresponds to a second audio signal from a physical audio interface coupled to the second remote user's computer; generate an emulated audio device to provide the first and second audio signals to a remote computing device; establish a communication link to the remote computing device, wherein the communication link corresponds to a physical connection communication protocol; and transmit the first and second audio signals to the remote computing device using the emulated audio device and using the communication link.

In some aspects, the techniques described herein relate to a non-transitory machine-readable storage medium, wherein the audio stream is uncompressed.

In some aspects, the techniques described herein relate to a non-transitory machine-readable storage medium, wherein the audio signal is uncompressed.

In some aspects, the techniques described herein relate to a non-transitory machine-readable storage medium, wherein the first audio information includes a first audio stream and a first time code.

In some aspects, the techniques described herein relate to a non-transitory machine-readable storage medium, wherein the second audio information including a second audio stream and a second time code.

In some aspects, the techniques described herein relate to a non-transitory machine-readable storage medium, further comprising: generate a first synchronized audio signal using the first audio stream, the first time code, and the second time code; generate a second synchronized audio signal using the second audio stream, the first time code, and the second time code, wherein the first and second synchronized audio signals are synchronized with each other; and generate an emulated audio device to provide the first and second synchronized audio signals to a remote computing device.

In some aspects, the techniques described herein relate to a non-transitory machine-readable storage medium, wherein the first audio stream comprises a plurality of audio stream channel signals corresponding to audio signals from a plurality of physical audio interfaces coupled to the first user's computer.

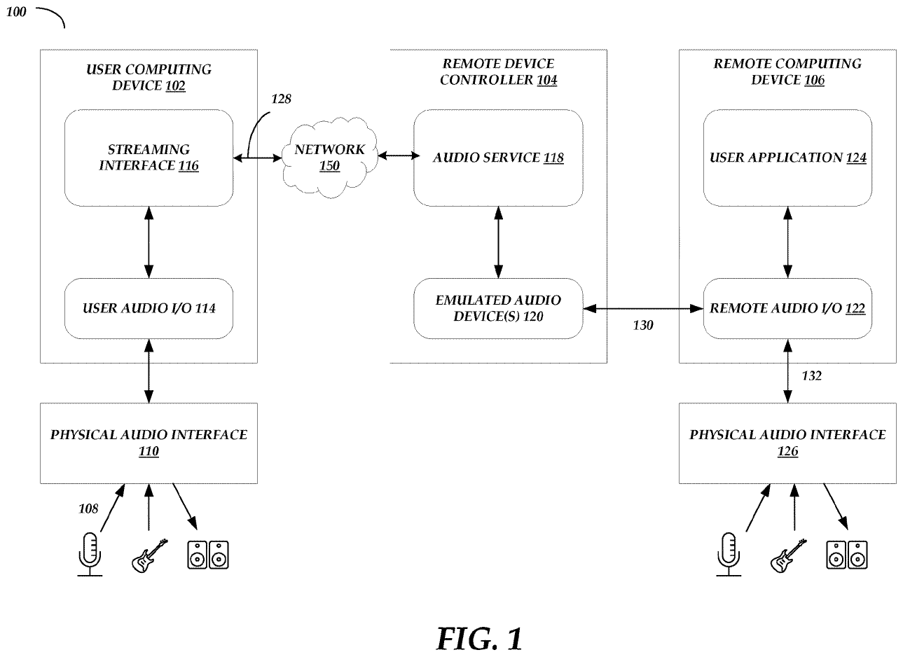

FIG. 1 illustrates one embodiment of a remote emulated audio system 100 configured to provide audio signals from a user computing device to a remote computing device. Remote emulated audio system 100 includes user computing device 102, remote device controller 104, and remote computing device 106.

As illustrated in FIG. 1, user computing device 102 may be coupled to physical audio interface 110. In some aspects, physical audio interface 110 may be any communication interface configured to physically connect to an audio device 108. For example, physical audio interface 110 may include USB, Thunderbolt, and/or any other interface compatible with the user computing device. In some aspects, physical audio interface 110 may housed within the user computing device 102. Audio device 108 may include any device capable of inputting or outputting an audio signal. For example, audio device 108 may include a microphone, a speaker, a headphone, an instrument, a musical instrument, or an electronic instrument.

User computing device 102 may be any device capable of receiving and transmitting audio streams. User computing device 102 may include personal computing devices, laptop computing devices, tablet computing devices, electronic reader devices, wearable computing devices, mobile devices (e.g., cellular and other mobile phones, smart phones, media players, handheld gaming devices, etc.), streaming media devices, and various other electronic devices and appliances.

As illustrated in FIG. 1, user computing device 102 includes user audio input/output (I/O) 114 and streaming interface 116. User audio I/O 114 may be coupled to physical audio interface 110 and configured to receive an audio signal from the physical audio interface 110. Streaming interface 116 may be configured to send an audio stream from user computing device 102 to remote device controller 104. Streaming interface 116 may be any interface capable of connecting to and transmitting audio streams from the user computing device 102 to the remote device controller 104. For example, streaming interface 116 may include a web-based browser interface, an application interface, or any other similar interface that may connect to the remote device controller 104. In some aspects, more than one audio channel from multiple audio devices may be streamed as part of the audio stream from the user computing device 102 to the remote device controller 104.

It is noted that an audio signal may be transmitted between a physical audio interface and an audio I/O of a computing device, such as user audio I/O 114, via a wired or physical connection. By contrast, it is noted that an audio stream may be transmitted between devices, such as user computing device 102 and remote device controller 104, via a wireless connection.

As illustrated, user computing device 102 is communicatively coupled to remote device controller 104 through streaming link 128. In some embodiments, user computing device 102 may be communicatively coupled to remote device controller 104 through streaming link 128 over a network 150. For example, streaming link 128 between the user computing device 102 and the remote device controller 104 may include wireless communication such as BLUETOOTH®, Wi-Fi®, according to an IEEE 802 standard, a network, etc. In an aspect, an audio stream sent over streaming link 128 may be uncompressed. Streaming link 128 may connect user computing device 102 and remote device controller 104 in both directions, as indicated in FIG. 1 by the double arrows.

Remote device controller 104 may be any device capable of receiving an audio stream and generating an emulated audio device. As shown, remote device controller 104 includes audio service 118 and emulated audio device(s) 120. Audio service 118 may be any service capable of receiving audio streams from user computing device 102. In another example, remote device controller 104 may be configured to send an audio stream to the user computing device 102.

Remote device controller 104 may generate emulated audio device(s) 120. Emulated audio device(s) 120 may be any software-based application or service configured to emulate the physical audio interface 110 with respect to the remote computing device 106. As used herein, an “emulated” device may refer to a software-based process that performs as an expected hardware accessory might perform. As illustrated, emulated audio device(s) 120 is communicatively coupled to remote computing device 106 through communication link 130. For example, remote computing device 106 may be connected to remote device controller 104 using a wired connection, such as USB, USB-C, Thunderbolt, etc.

In an illustrative and non-limiting example, the remote device controller 104 may receive an audio stream originating from a USB-input microphone. In this example, the remote controller 104 may emulate the USB-type connection between the remote device controller 104 and the remote computing device 106 via communication link 130. By emulating the physical connection between physical audio interface 110 and user audio I/O 114, the remote computing device 106 “sees” the incoming audio stream as if it were being input through a wired connection from a physical audio interface.

Remote computing device 106 may be any device capable of receiving and transmitting audio streams. Remote computing device 106 may include personal computing devices, laptop computing devices, tablet computing devices, electronic reader devices, wearable computing devices, mobile devices (e.g., cellular and other mobile phones, smart phones, media players, handheld gaming devices, etc.), streaming media devices, and various other electronic devices and appliances.

As illustrated in FIG. 1, remote computing device 106 includes remote audio I/O 122 and user application 124. Similar to the user audio I/O 114, the remote audio I/O 122 may be coupled to physical audio interface 126 and configured to receive an audio signal from the physical audio interface 126. Remote audio I/O 122 may also be configured to receive an audio signal from the emulated audio device(s) 120 via communication link 130. User application 124 may be any application on remote computing device 106 configured to process audio streams from remote audio I/O 122.

In some examples, audio signals from physical audio interface 126 may be transmitted from the remote computing device 106 through emulated audio device 120, audio service 118, to user computing device 102.

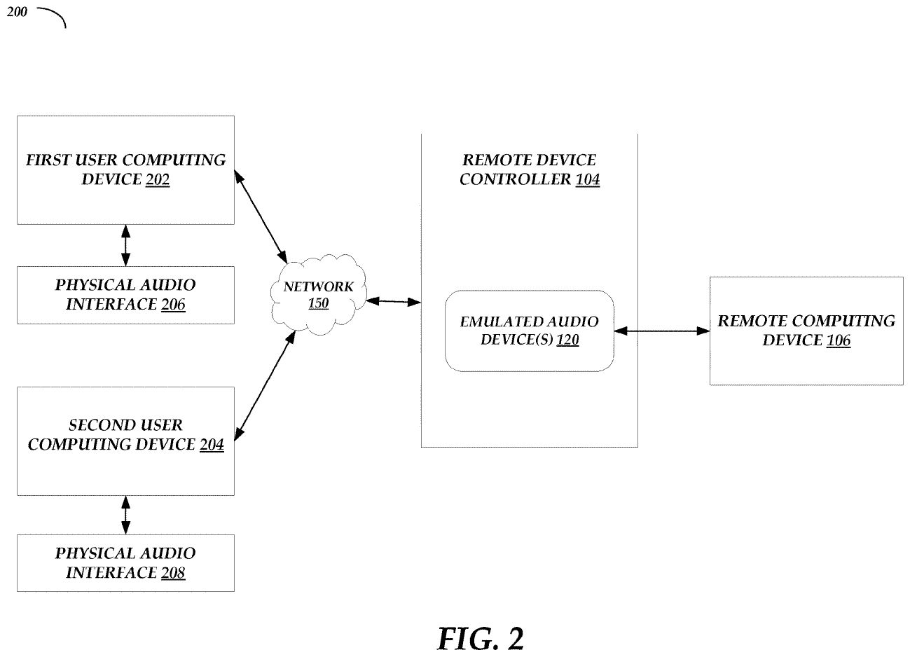

FIG. 2 is an example block diagram illustrating a collaborate remote emulated audio system 300. Collaborate remote emulated audio system 200 includes a first user computing device 202, a second user computing device 204, a remote device controller 104, a remote computing device 106, and network 150.

First user computing device 202 and second user computing device 204 may be any devices capable of receiving and transmitting audio streams. In an example, first user computing device 202 and second user computing device 304 may contain all the features and functionalities of user computing device 102 as described above. User computing devices may include personal computing devices, laptop computing devices, tablet computing devices, electronic reader devices, wearable computing devices, mobile devices (e.g., cellular and other mobile phones, smart phones, media players, handheld gaming devices, etc.), streaming media devices, and various other electronic devices and appliances.

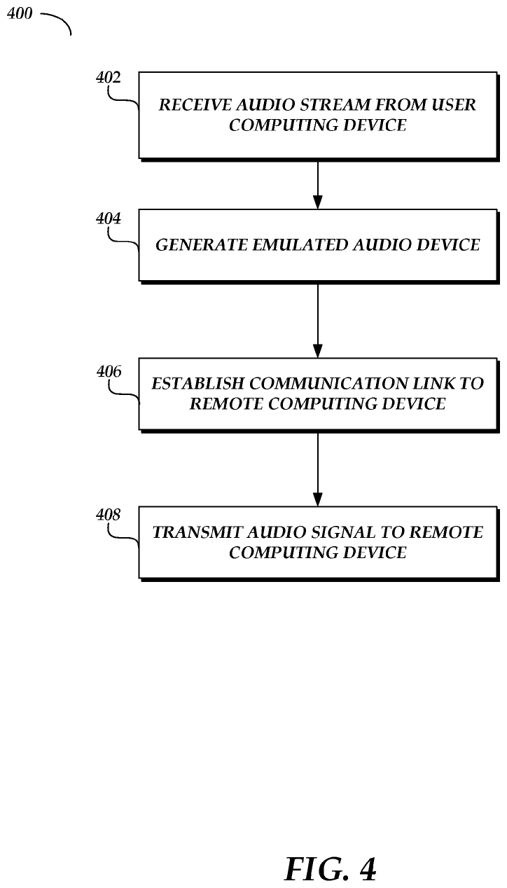

As illustrated in FIG. 2, first user computing device 202 and second user computing device 204 may be communicatively coupled to the remote device controller 104 to send audio streams. In an example, first user computing device 202 and second user computing device 204 may be communicatively coupled to the remote device controller 104 to receive audio streams, e.g., such as through network 150. First user computing device 202 and second user computing device 204 may be configured to send audio streams to remote device controller 104, such as through network 150. Although not illustrated in FIG. 4, any streaming interface, such as a web-based browser or application may be used to connect to and transmit audio streams from the computing devices 102 to the remote device controller 104. In some aspects, more than one audio channel may be streamed as part of the audio stream from the first user computing device 202 or second user computing device 204 to the remote device controller 104.

As described above with respect to FIG. 1, remote device controller 104 may generate emulated audio device(s) 120. Emulated audio device(s) 120 may be any software-based application or service configured to emulate the connection between physical audio interfaces 206 and 208 and the computing devices 202 and 204, respectively. In an example, emulated audio device(s) 120 may connect to the remote computing device 106 via a physical communication link. For example, remote computing device 106 may be connected to remote device controller 104 using a wired connection, such as USB, USB-C, Thunderbolt, etc.

As described above with respect to FIG. 1, remote computing device 106 may be any device capable of receiving and transmitting audio streams. Remote computing device 106 may include personal computing devices, laptop computing devices, tablet computing devices, electronic reader devices, wearable computing devices, mobile devices (e.g., cellular and other mobile phones, smart phones, media players, handheld gaming devices, etc.), streaming media devices, and various other electronic devices and appliances.

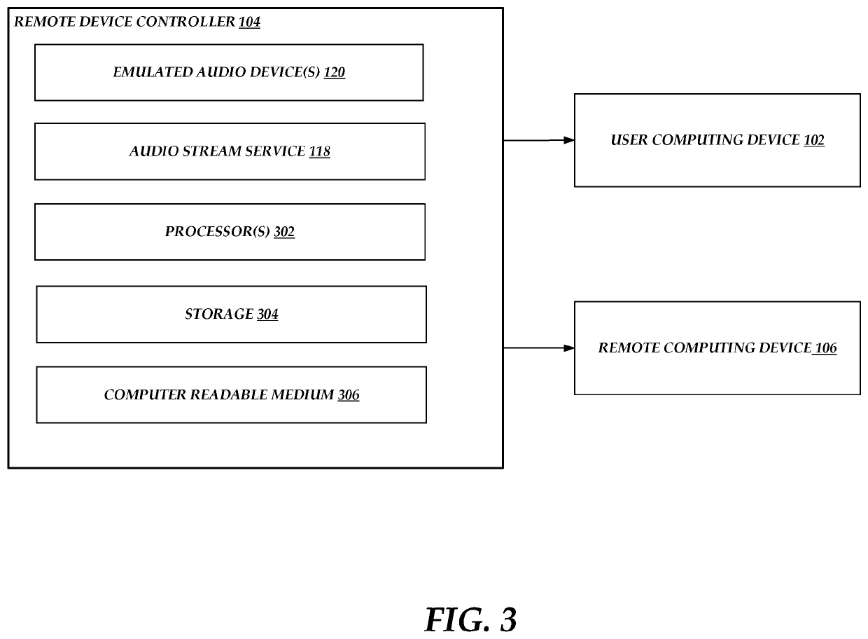

FIG. 3 is a block diagram illustrating components of a remote device controller 104 configured to execute processes for managing a remote emulated audio system. In the illustrated embodiment, remote device controller 104 includes audio service 118; emulated audio device(s) 120; processor(s) 302, such as a physical central processing unit (“CPU”), storage 304, such as such as random access memory (“RAM”) and/or other volatile non-transitory computer-readable media; and computer readable medium 306, such as such a high density disk (“HDD”), solid state drive (“SDD”), flash drives, and/or other persistent non-transitory computer-readable media.

As illustrated, remote device controller 104 may be communicatively coupled to user computing device 102. Also as illustrated, remote device controller 104 may be communicatively coupled to remote computing device 106.

FIG. 4 is a flow diagram depicting an example routine 400 for providing an audio signal through a remote emulated audio system to a remote computing device. Routine 400 may be implemented by a remote device controller 104 within remote emulated audio system 100.

At block 402, the remote device controller 104 receives an audio stream from a user computing device. In an example, the audio stream corresponds to an audio signal from a physical audio interface coupled to the remote user's computer. In an example, the audio signal is uncompressed. In an example, the audio stream is uncompressed.

In an example, the audio stream comprises a plurality of audio stream channel signals corresponding to audio signals from a plurality of physical audio interfaces coupled to the user's computer. In an example, the emulated audio device is one of a plurality of emulated audio devices corresponding to the plurality of audio stream channel signals.

In an example, the audio stream includes a time code, and wherein the emulated audio device to provide the time code to the remote computing device.

At block 404, the remote device controller 104 generates an emulated audio device 120. In an example, the emulated audio device 120 provides the audio signal to a remote computing device 106 using the audio stream, wherein the emulated audio device 120 emulates the physical audio interface 110 coupled to the user computing device 102.

In an example, the remote computing device receives the audio stream input signal by communicating with the user computing device over a network.

At block 406, the remote device controller 104 establishes a communication link 130 to the remote computing device 106. In an example, the communication link 130 corresponds to a physical connection communication protocol.

At block 408, remote device controller 104 transmits the audio signal to the remote computing device 106. In an example, the remote device controller 104 transmits the audio signal to the remote computing device 106 using the emulated audio device 120 and the communication link 130.

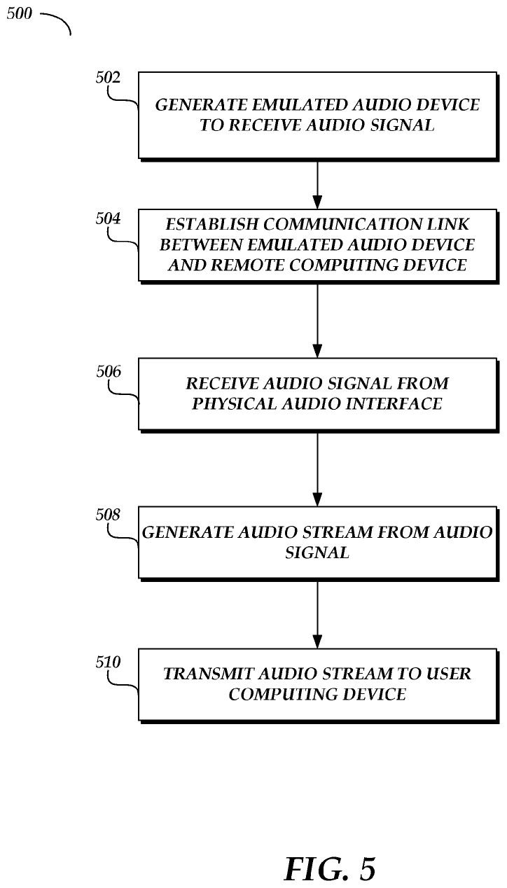

FIG. 5 is a flow diagram depicting an example routine 600 for providing an audio signal through a remote emulated audio system to a user computing device. Routine 600 may be implemented by a remote device controller 104 within remote emulated audio system 100.

At block 502, remote device controller 104 generates an emulated audio device 120 to receive an audio signal. In an example, the audio signal may be from the remote computing device 106. In an example, the audio signal is uncompressed.

At block 504, remote device controller 104 establishes a communication link 130 between the emulated audio device 120 and the remote computing device 106. In an example, communication link 130 corresponds to a physical connection communication protocol.

At block 506, remote device controller 104 receives an audio signal from a physical audio interface 126. In an example, physical audio interface 126 may be coupled to the remote computing device 106.

At block 508, remote device controller 104 generates an audio stream from the audio signal. In an example, the audio stream corresponds to the audio signal received from the physical audio interface 126 coupled to the remote computing device 106.

At block 510, remote device controller 104 transmits an audio stream to the user computing device 102. In an example, the audio stream is uncompressed. In an example, the remote device controller 104 transmits the audio stream by communicating with the user computing device over a network. In an example, the audio stream comprises a plurality of audio stream channel signals corresponding to audio signals from a plurality of physical audio interfaces coupled to the remote computing device.

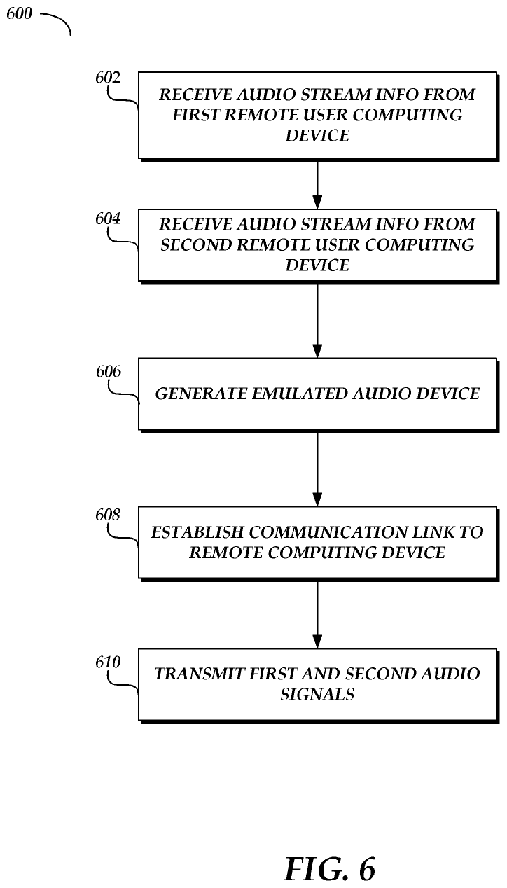

FIG. 6 is a flow diagram depicting an example routine 600 or providing a collaborate remote emulated audio interface. Routine 600 may be implemented by a remote device controller 104 within remote emulated audio system 100.

At block 602, remote device controller 104 receives audio stream information from a first remote user computing device. In an example, the first audio stream corresponds to a first audio signal from a physical audio interface coupled to the first remote user's computer. In an example, the first audio information includes a first audio stream and a first time code.

At block 604, remote device controller 104 receives audio stream information from a second remote user computing device. In an example, the second audio stream corresponds to a second audio signal from a physical audio interface coupled to the second remote user's computer. In an example, the second audio information including a second audio stream and a second time code.

In an example, the first and second audio signals are uncompressed. In an example, the first and second audio streams are uncompressed.

At block 606, remote device controller 104 generates an emulated audio device. In an example, remote device controller 104 generates the emulated audio device to provide the first and second audio signals to a remote computing device. In an example, the remote device controller 104 is further configured to generate a first synchronized audio signal using the first audio stream, the first time code, and the second time code. In an example, remote device controller 104 is further configured to generate a second synchronized audio signal using the second audio stream, the first time code, and the second time code, wherein the first and second synchronized audio signals are synchronized with each other. In an example, remote device controller 104 is further configured to generate an emulated audio device to provide the first and second synchronized audio signals to a remote computing device. In an example, the first audio stream comprises a plurality of audio stream channel signals corresponding to audio signals from a plurality of physical audio interfaces coupled to the first user's computer.

At block 608, remote device controller 104 establishes a communication link to the remote computing device. In an example, the communication link corresponds to a physical connection communication protocol.

At block 610, remote device controller 104 transmits the first and second audio signals to the remote computing device using the emulated audio device and using the communication link.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules, including one or more specific computer-executable instructions, that are executed by a computing system. The computing system may include one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might,” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached FIG.s should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

What is claimed is:

1. A non-transitory machine-readable storage medium comprising instructions executable by a processing resource of a computing device to cause the computing device to:
receive an audio stream from a user computing device, wherein the audio stream corresponds to an audio signal from a physical audio interface coupled to the remote user's computer;
generate an emulated audio device to provide the audio signal to a remote computing device using the audio stream, wherein the emulated audio device emulates the physical audio interface coupled to the user computing device;
establish a communication link to the remote computing device, wherein the communication link corresponds to a physical connection communication protocol; and
transmit the audio signal to the remote computing device using the emulated audio device and the communication link.

2. The non-transitory machine-readable storage medium of claim 1, wherein the audio signal is uncompressed.

3. The non-transitory machine-readable storage medium of claim 2, wherein the audio stream is uncompressed.

4. The non-transitory machine-readable storage medium of claim 1, wherein the instructions further cause the remote computing device to receive the audio stream input signal by communicating with the user computing device over a network.

5. The non-transitory machine-readable storage medium of claim 1, wherein the audio stream comprises a plurality of audio stream channel signals corresponding to audio signals from a plurality of physical audio interfaces coupled to the user's computer.

6. The non-transitory machine-readable storage medium of claim 5, wherein the emulated audio device is one of a plurality of emulated audio devices corresponding to the plurality of audio stream channel signals.

7. The non-transitory machine-readable storage medium of claim 1, wherein the audio stream includes a time code, and wherein the emulated audio device to provide the time code to the remote computing device.

8. A non-transitory machine-readable storage medium comprising instructions executable by a processing resource of a computing device to cause the computing device to:
generate an emulated audio device to receive an audio signal from a remote computing device;
establish a communication link between the emulated audio device and the remote computing device, wherein the communication link corresponds to a physical connection communication protocol;
receive an audio signal from a physical audio interface coupled to the remote computing device;
generate an audio stream corresponding to the audio signal received from the physical audio interface coupled to the remote computing device; and
transmit the audio stream to a user computing device.

9. The non-transitory machine-readable storage medium of claim 8, wherein the audio signal is uncompressed.

10. The non-transitory machine-readable storage medium of claim 9, wherein the audio stream is uncompressed.

11. The non-transitory machine-readable storage medium of claim 8, wherein the instructions further cause the remote computing device to transmit the audio stream by communicating with the user computing device over a network.

12. The non-transitory machine-readable storage medium of claim 8, wherein the audio stream comprises a plurality of audio stream channel signals corresponding to audio signals from a plurality of physical audio interfaces coupled to the remote computing device.

13. The non-transitory machine-readable storage medium of claim 12, wherein the emulated audio device is one of a plurality of emulated audio devices corresponding to the plurality of audio stream channel signals.

14. A non-transitory machine-readable storage medium comprising instructions executable by a processing resource of a computing device to cause the computing device to:
receive first audio stream information from a first user computing device, wherein the first audio stream corresponds to a first audio signal from a physical audio interface coupled to the first remote user's computer;
receive second audio stream information from a second user's computer, wherein the second audio stream corresponds to a second audio signal from a physical audio interface coupled to the second remote user's computer;
generate an emulated audio device to provide the first and second audio signals to a remote computing device;
establish a communication link to the remote computing device, wherein the communication link corresponds to a physical connection communication protocol; and
transmit the first and second audio signals to the remote computing device using the emulated audio device and using the communication link.

15. The non-transitory machine-readable storage medium of claim 14, wherein the first and second audio signals are uncompressed.

16. The non-transitory machine-readable storage medium of claim 15, wherein the first and second audio streams are uncompressed.

17. The non-transitory machine-readable storage medium of claim 14, wherein the first audio information includes a first audio stream and a first time code.

18. The non-transitory machine-readable storage medium of claim 14, wherein the second audio information including a second audio stream and a second time code.

19. The non-transitory machine-readable storage medium of claim 14, further comprising:
generate a first synchronized audio signal using the first audio stream, the first time code, and the second time code;
generate a second synchronized audio signal using the second audio stream, the first time code, and the second time code, wherein the first and second synchronized audio signals are synchronized with each other; and
generate an emulated audio device to provide the first and second synchronized audio signals to a remote computing device.

20. The non-transitory machine-readable storage medium of claim 14, wherein the first audio stream comprises a plurality of audio stream channel signals corresponding to audio signals from a plurality of physical audio interfaces coupled to the first user's computer.
